(19) United States
(12) Patent Application Publication
(10) Pub. No.: US 2023/0413980 A1
(43) Pub. Date: Dec. 28, 2023

(54) Backpack with Integrated Power Supply

(71) Applicant: Stephen T. Williams, Sevierville, TN (US)

(72) Inventor: Stephen T. Williams, Sevierville, TN (US)

(21) Appl. No.: 18/312,664

(22) Filed: May 5, 2023

Related U.S. Application Data
(60) Provisional application No. 63/356,274, filed on Jun. 28, 2022.

(51) Int. Cl. A45F 3/04; H02S 10/40

(52) U.S. Cl. CPC A45F 3/04; H02S 10/40; A45F 2003/003

(57) ABSTRACT

A backpack with an integrated power supply connected to a removable solar panel in a panel pocket to receive solar energy to power the integrated power supply. The integrated power supply is configured to supply power to the user in multiple forms, including at least one USB charging station to power devices.

### FIELD

The present disclosure relates to backpacks. More particularly, the disclosure relates to an improved backpack with an integrated power supply with a solar power panel connected to a USB charging station so that a user may cultivate solar energy to power their devices such as headlamps, cell phones, or computers. The integrated power supply is also connectable to a GPS tracking device and LED shoulder strap lights and supplies power to the GPS tracking device and LED shoulder strap lights.

### BACKGROUND

Improvement is desired in the field of backpacks for use in remote areas or areas without readily accessible electrical power. Conventional backpacks have many shortcomings. The majority lack the ability to power devices remotely. Some backpacks require a user to pack a power source, leading to potential damage issues to the power source or backpack. Current backpacks lack a renewable energy source, requiring a connection to a battery or electrical power grid. The present disclosure advantageously provides a backpack with an integrated power source that offers many advantages and overcomes many shortcomings of conventional backpacks.

In particular, the present disclosure provides a backpack with an integrated power supply to allow the user access to a USB charging station to power devices of the user. The integrated power supply of the backpack is powered by a solar panel attached to the front of the backpack so the integrated power supply can receive additional power while the backpack is in use.

### SUMMARY

The disclosure provides an improved backpack having a backpack with an electrical power supply integrated into the backpack.

In one aspect a backpack according to the disclosure includes

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 shows the front of a backpack with an integrated power supply according to the disclosure.

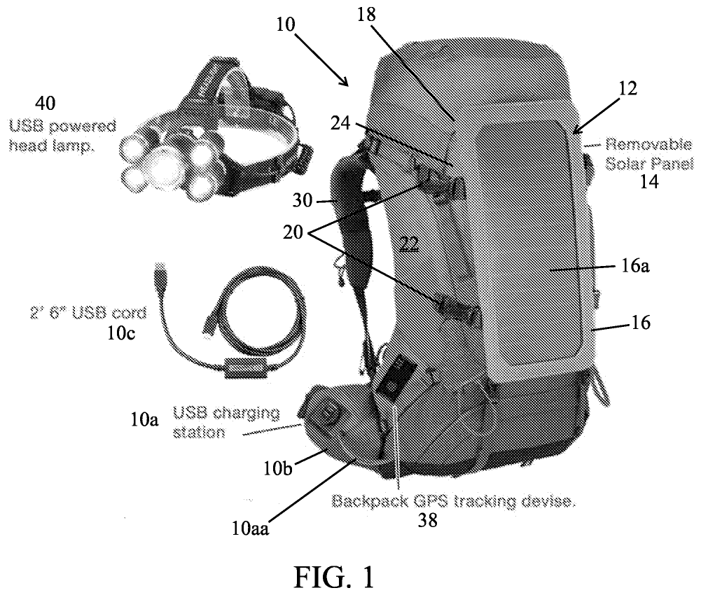

FIG. 2 show the rear of the backpack.

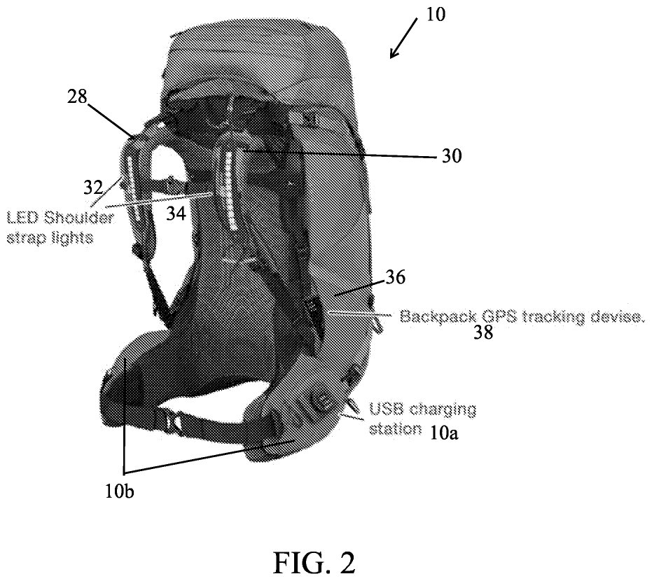

### DETAILED DESCRIPTION

With reference to the drawings, there is shown a backpack 10 according to the disclosure configured to include a power bank or power supply 10a integrated into the backpack 10 in a manner to be secure and protected. This protects potential damage issues to the power supply 10a and the backpack 10.

In brief overview, the backpack 10 is advantageously configured to allow a user access to power while hiking or the like while traveling with the backpack 10. As described below, the backpack 10 includes a solar panel to allow the user access to renewable energy to power the power supply, and includes a GPS tracking system, USB charging stations and LED shoulder lights all powered by the power supply.

The power supply 10a is desirably fixedly integrated onto one of the left or right waist belts 10b of the backpack 10 to enable convenient access thereto. Thus, the power supply 10a is not exposed and is protected. Conventionally just placing a power supply in the cargo hold of a backpack leaves the power supply vulnerable to damage and to damage the backpack and the cargo contents. The power supply 10a is desirably configured as a rechargeable USB charging station of a type having at least four types of USB cord connections for connection to portable electronic devices of the user. A USB extension cable 10c is included.

The backpack 10 includes a panel pocket 12 that houses a removable solar panel 14. The removable solar panel 14 can be taken out of the panel pocket 12 for examination, replacement, repairs, or another reason. The removable solar panel 14 is connected to the power supply 10a as by an internal electrical cable or wire 10aa to supply electrical charging from the output of the solar panel 14 to charge the power supply 10a.

The panel pocket 12 includes a panel pocket front wall 16 and a panel pocket back wall 18. The panel pocket front wall 16 includes a transparent portion 16a and provides a cover piece that enables the removable solar panel 14 to receive solar energy in the form of sunlight. The transparent portion 16a may be connected to the front wall 16 directly or by a zipper. The panel pocket front wall 16 and the panel pocket back wall 18 may be made with a thin, flexible vinyl material, the same material as the backpack 10, or another material. The panel pocket back wall 18 may be connected to the backpack 10 as by detachable buckles 20 to easily remove or connect the solar panel 14 and panel pocket 12.

The backpack 10 also includes a storage pocket 22 to allow the user to store items. The storage pocket 22 includes a storage pocket front wall 24 and storage pocket back wall 26. The storage pocket back wall 26 connects to one of the buckles 20 to removably attach the storage pocket 22 and the panel pocket 12.

The storage pocket 22 includes a first shoulder strap 28 and second shoulder strap 30 to allow the user to transport the backpack 10. The first shoulder strap 28 includes a first shoulder strap illumination source 32 and a second shoulder strap illumination source 34. The first shoulder strap illumination source 32 and the second shoulder strap illumination source 34 are preferably LED light sources integrated into the first shoulder strap 28 and the second shoulder strap 30, respectively, and powered by the power supply 10a to allow the user access to a renewable light source.

The storage pocket includes a lower side GPS pocket 36 on an exterior lower side. The lower side GPS pocket 36 includes a GPS tracking device 38 powered by the power supply 10a so the user may be located if desired while traveling remotely.

Some embodiments include a detachable illumination source such as an LED headlamp 40 configured to be attachable and detachable from the backpack 10. The LED headlamp 40 is chargeable by the power supply 10a.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A backpack, comprising:
a backpack;
a power supply integrated into the backpack and having two or more electrical power connections with at least one of the two or more electrical power connections configured to receive electric power from solar energy cells;
a solar panel removably positionable onto the backpack to convert exterior solar energy to solar energy cells to power the integrated power supply; and
a panel pocket that houses the removable solar panel on the backpack.

2. The backpack of claim 1, wherein the backpack includes a waist belt and the power supply is integrated internally within the waist belt.

3. The backpack of claim 1, further comprising one or more illumination sources located on a shoulder strap of the backpack and powered by the power supply.

4. The backpack of claim 1, further comprising one or more detachable illumination sources detachably mounted to the backpack and powered by the integrated power supply.

5. The backpack of claim 1, further comprising an electrical charging station located on the backpack and having at least one electrical cord connection located on a waist belt of the backpack.

6. The backpack of claim 1, further comprising a GPS tracker located on the backpack and powered by the integrated power supply.

7. The backpack of claim 1, wherein the panel pocket has a transparent portion for sunlight exposure to the solar panel located in the panel pocket.

8. A backpack, comprising:
a backpack having a waist belt, at least one shoulder strap and a panel pocket;
a power supply integrated into the waist belt of the backpack and having two or more electrical power connections with at least one of the two or more electrical power connections configured to receive electric power from solar energy cells;
an illumination source located on the at least one shoulder strap of the backpack and powered by the power supply; and
a solar panel removably positionable in the panel pocket, the panel pocket having a transparent portion for exposure of the solar panel to sunlight, wherein the solar panel is operative to convert exterior solar energy from the sunlight to solar energy cells to power the integrated power supply.
